(19) United States
(12) Patent Application Publication
(10) Pub. No.: US 2011/0075976 A1
(43) Pub. Date: Mar. 31, 2011

(54) SUBSTRATES AND GRIPPERS FOR OPTICAL FIBER ALIGNMENT WITH OPTICAL ELEMENT(S) AND RELATED METHODS

(76) Inventor: James Scott Sutherland, Corning, NY (US)

(21) Appl. No.: 12/570,714

(22) Filed: Sep. 30, 2009

(51) Int. Cl. G02B 6/36

(52) U.S. Cl. 385/88; 385/52; 385/134

(57) ABSTRACT

Apparatuses and methods for the passive alignment of an optical fiber over an optical element on a substrate are disclosed. An optical element and at least one gripper element may be provided on the substrate, wherein the at least one gripper element is positioned in an axial path defined by the optical element. Thus, when an optical fiber is moved along the axial path until an end of the optical fiber makes contact with the at least one gripper element, the optical fiber is aligned with the optical element. In addition, methods of aligning an optical fiber over an optical element on a substrate are disclosed. Further, the optical fibers may be laser angle-cleaved optical fibers with shaped fiber ends, such as laser angle-cleaved wedge or taper structures, as examples.

### BACKGROUND

1. Field of the Disclosure

The technology of the disclosure relates to the alignment of an optical fiber(s) to an optical element(s) that emits light onto and/or receives light from the optical fiber(s).

2. Technical Background

Optical systems can include optical elements that transmit light onto and receive light from an optical fiber for light signal transfer. In such systems, alignment of the optical elements with respect to the optical fiber optimizes light signal transfer between the optical elements and the optical fiber. It may be desirable in many photonic applications to have precise alignment of optical fibers to optical elements that emit or receive light. Examples of such optical elements include optical components such as, but not limited to, laser sources, detectors, lens, filters, isolators, or other optical fibers. In this regard, the end of an optical fiber is positioned and aligned over an optical element on a substrate. Active alignment of optical elements may be dependent on operator skill in determining the alignment of the elements and affixing the elements in place. However, active alignment also typically employs expensive equipment to generate and monitor optical signals to assist or confirm proper alignment.

An alternative to active alignment is passive alignment. Passive alignment involves aligning optical elements by mechanical means and securing the elements in place. Typical mechanical alignment means include V-grooves, alignment blocks, jigs, and fixtures adapted to align an optical element to a substrate. Passive alignment may be advantageous in terms of cost in that it may not require equipment to generate and monitor optical signals to assist or confirm alignment of the optical elements with optical fiber. However, one possible trade off of passive alignment is a less accurate alignment. Another possible trade off of passive alignment is that it may result in a reduction in light signal transfer due to the absence of equipment to generate and monitor optical signals to assist or confirm proper alignment.

### SUMMARY OF THE DETAILED DESCRIPTION

Embodiments disclosed in the detailed description include apparatuses and methods for the alignment of an optical fiber over an optical element on a substrate. In one embodiment, a substrate having an optical element and at least one gripper element is provided. The at least one gripper element is positioned proximate the optical element along an axial path of an optical fiber, such that when the optical fiber is moved along the axial path until an end of the optical fiber makes contact with the at least one gripper element, the optical fiber is aligned with the active optical element. By positioning the one or more grippers in the axial path of the optical fiber such that an optical fiber may be moved along the axial path until the end of the optical fiber comes in contact with the one or more grippers, the optical fiber may be easily and accurately aligned over an optical element on a substrate. In certain embodiments, the optical fibers may be laser angle-cleaved optical fibers with shaped fiber ends, such as laser angle-cleaved wedge or taper structures. The optical element(s) may be an active optical element(s).

Other embodiments include methods of aligning an optical fiber over an optical element on a substrate. One exemplary method comprises providing at least one gripper element proximate the optical element and in an axial path of the optical fiber, and moving the optical fiber along the axial path until the optical path is in contact with the at least one gripper element such that the optical fiber is aligned with the optical element.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a planar view of an exemplary embodiment of grippers on a planar substrate arranged proximate an optical element;

FIG. 2 is a planar view showing an exemplary embodiment of an initial insertion of a laser angle-cleaved optical fiber into grippers arranged proximate an optical element on a planar substrate;

FIG. 3A is a side view of an exemplary embodiment of a laser angle-cleaved optical fiber after insertion into the grippers, showing fiber motion as pressure is applied along an axis of the optical fiber;

FIG. 3B is a side view of an exemplary embodiment of a laser angle-cleaved optical fiber after insertion showing contact between a tip of the laser angle-cleaved optical fiber and a gripper positioned in an axial path of a laser angle-cleaved optical fiber;

FIG. 4 is a planar view of an exemplary embodiment of a laser angle-cleaved optical fiber held in position by grippers over an optical element;

FIG. 5 is a side view of an exemplary embodiment of a laser angle-cleaved optical fiber forced down into contact with an optical element by a gripper sidewall;

FIG. 6 is a planar view showing an exemplary embodiment of self-alignment of a laser angle-cleaved optical fiber to an optical element using an alternative angled gripper alignment;

FIG. 7 is a planar view showing an exemplary embodiment of self-alignment of a laser angle-cleaved optical fiber to an optical element using an alternative C-shaped gripper embodiment;

FIG. 8 is an exemplary embodiment of side tapers on an end of a laser angle-cleaved optical fiber for self-alignment to an optical element;

FIG. 9 is a planar view showing an exemplary embodiment of a laser angle-cleaved optical fiber with side tapers being self-aligned to an optical element using a C-shaped gripper;

FIG. 10 is a side view of an exemplary embodiment of a tip-removed laser angle-cleaved optical fiber being self-aligned via grippers over an optical element;

FIG. 11A illustrates a standard ultraviolet (UV) exposure process used to fowl polymer grippers, where the direction of the UV exposure is close to the substrate normal direction;

FIG. 11B illustrates a modified UV exposure process used to form polymer grippers with steeper sidewall angles, wherein at least one direction of the UV exposure is at a sharper angle with respect to the substrate normal direction; and

FIG. 12 is a side view showing an alternative exemplary embodiment of self-alignment of a laser angle-cleaved optical fiber to an optical element.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed in the detailed description include apparatuses and methods for the alignment of an optical fiber over an optical element on a substrate using at least one gripper positioned proximate the optical element and in an axial path of the optical fiber such that the end of the optical fiber is in contact with the at least one gripper. By positioning the at least one gripper in the axial path of the optical fiber such that the end of the optical fiber is in contact with the at least one gripper, the optical fiber can be accurately aligned over an optical element on a substrate. In certain embodiments, the optical fibers may be laser angle-cleaved optical fibers with shaped fiber ends, such as laser angle-cleaved wedge or taper structures.

Low-cost passive alignment of optical fiber and fiber arrays to active devices (lasers and detectors) may be addressed using various fiber alignment structures. For example, fibers may be aligned to active devices using silicon V-groove structures or multi-layer ceramic substrates with integrated grooves. Fibers may also be held in place using deformable plastic, metal, or polymeric members that apply downward pressure on fibers to hold them in the groove structure. Such structures are referred to as “grippers” or “restraining members.”

The grippers according to one embodiment may be formed in a photosensitive elastic polymeric material that is photolithographically patterned on a planar substrate. The grippers can be created by first spin depositing a relatively thick layer (e.g., 50-200 μm) of polymer material over the entire surface of the substrate. Photolithographic exposure and development processing creates a significant sidewall undercut, with the topside width of the gripper always wider than the bottom width.

The grippers may be formed adjacent to regions where optical components are to be held in place. For example, when forming grippers for optical fibers two parallel grippers may be generally positioned on either side of the location where the optical fiber is to be positioned. The gap between the parallel grippers may be set to be less than the diameter of an optical fiber at the top and more than the diameter of an optical fiber at the bottom. When the optical fiber is inserted between the parallel grippers, each gripper deforms slightly. After application of sufficient pressure on the optical fiber, the bottom surface of the optical fiber is in contact with the substrate surface. The gripper sidewalls may generate a compression force to hold the optical fiber in position in both the horizontal and vertical directions. The amount of pressure applied by the grippers can be modified by adjusting the gap between the grippers (via photolithography) or altering the properties of the gripper polymer material.

An advantage of using grippers, such as polymer grippers, is that it enables low-cost passive alignment of tapered fibers or fiber arrays to active optical devices. In some embodiments, alignment can be achieved with an accuracy of plus or minus 5 microns. In addition, the polymer gripper layout can be easily modified via photolithographic mask modification to accommodate any type of fiber end treatment (e.g., wedges or tapers).

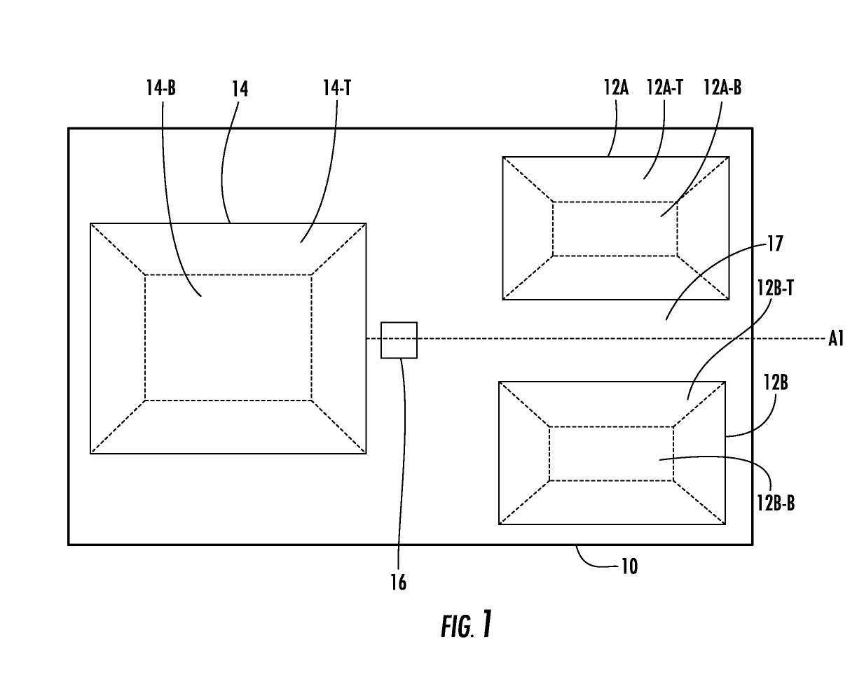

In this regard, FIG. 1 is a planar view of an exemplary embodiment of grippers on a planar substrate arranged near an active optical element, such as a vertical cavity surface emitting laser (VCSEL), or a photodetector. FIG. 1 provides an example plan layout of a planar substrate 10 having grippers 12A, 12B, and 14 and an optical element 16. The gripper 12A has a top surface 12A-T and a base 12A-B in this embodiment. The gripper 12B has a top surface 12B-T and a base 12B-B. The grippers 12A and 12B may be comprised of laterally spaced flexible strips attached to the surface of the substrate 10, thereby forming an axial path 17 that has an axis A1 that runs laterally through the optical element 16 on the substrate 10. The grippers 12A and 12B may be positioned such that that they are parallel to the axis A1, and may be referred to as side grippers.

The gripper 14 is a structure positioned such that it is along the axis A1 that runs laterally through the optical element 16 on the substrate 10. The gripper 14 has a top surface 14-T and a base 14-B. The gripper 14 may be positioned proximate the optical element 16 and on the opposite side of the optical element 16 from grippers 12A and 12B, and may be referred to as an end gripper.

The substrate 10 may include one or more optical elements 16. Although FIG. 1 only shows a single optical element 16, it is to be understood that there may be multiple optical elements 16. The optical element 16 may be a VCSEL device, a photodetector, or any other optical element, including but not limited to optical fibers, lenses, filters, lensed fibers, optical isolators, and the like. The optical element 16 may be designed to transfer light to and/or from optical fibers or other optical elements. Likewise, although FIG. 1 shows three grippers 12A, 12B, and 14, any number of grippers or other restraining members may be used to receive and align optical elements. The three grippers 12A, 12B, and 14 are photolithographically patterned near the optical element 16. The grippers 12A, 12B, and 14 may be made of a flexible polymer in one embodiment. Further, the grippers 12A, 12B, and 14 in one embodiment may be formed using a variety of techniques such as well-known lithographic processes using photopolymerizable compositions and the like.

For example, a photopolymerizable composition can be substantially uniformly deposited onto a substrate surface, such as the substrate 10. The photopolymerizable composition is then imagewise exposed to actinic radiation using a laser and a computer-controlled stage to expose precise areas of the composition with an ultraviolet laser beam, or a collimated ultraviolet (UV) lamp together with a photomask having a pattern of substantially transparent and substantially opaque areas. The nonimaged areas can then be removed with solvent, while leaving the imaged areas in the form of at least one gripping element on the substrate surface.

Alternatively, one or more of the grippers 12A, 12B, and 14 can be formed by using a soft, flexible embossing tool to pattern the polymerizable composition in the form of at least one gripper element on the substrate 10. Such soft tooling is commonly made with silicones. The composition is then cured and the tool is removed. The flexibility of the tool must be sufficient so that it can be removed from the cured polymer without damaging the grippers. The polymerizable composition may be cured by various means such as actinic radiation or heat, and should have the viscosity to conform to the raised features of the tool. After removing the tool from the cured composition, at least one gripper will remain on the substrate 10, depending on the nature of the pattern. The pattern of the tool may include a plurality of gripping elements to provide a substrate for aligning an array of optical fibers and lenses. Suitable polymeric compositions for making the gripping elements are disclosed in commonly assigned U.S. Pat. No. 6,266,472, which is incorporated herein by reference.

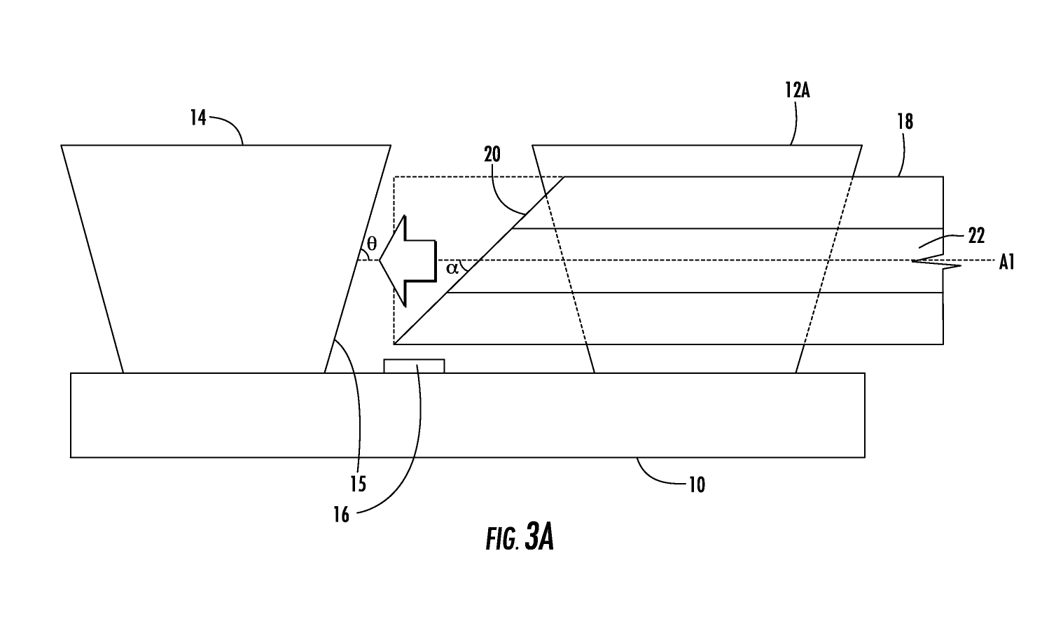

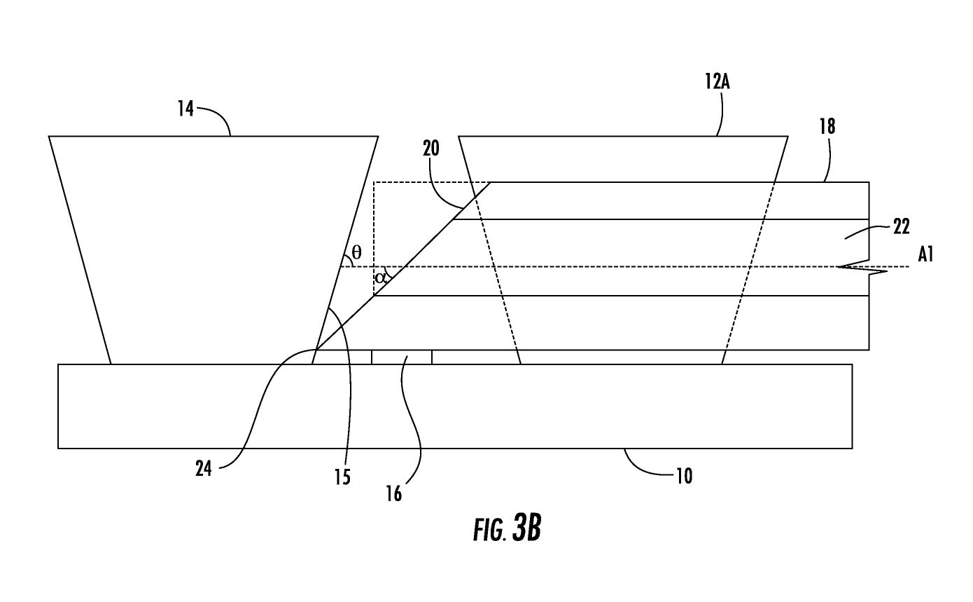

With continuing reference to FIG. 1, the side gripper 12A has a base 12A-B attached to a surface of the substrate 10 and a top surface 12A-T in a plane parallel to the plane of the substrate 10. The side gripper 12B has a base 12B-B attached to a surface of the substrate 10 and a top surface 12B-T in a plane parallel to the plane of substrate 10. The end gripper 14 has a base 14-B attached to a surface of the substrate 10 and a top surface 14-T in a plane parallel to the plane of the substrate 10. Each of the side grippers 12A and 12B and the end gripper 14 may have a top surface that is wider than its base, such that a footprint of the base of each of the grippers is smaller than the top surface of the grippers. This allows the grippers 12A, 12B, and 14 to contact an optical fiber and generate a compression force to hold the optical fiber in position in both the horizontal and vertical directions, while still allowing the optical fiber to move in the axial path 17 along the axis A1. This will be shown in more detail in FIGS. 3A and 3B and discussed below.

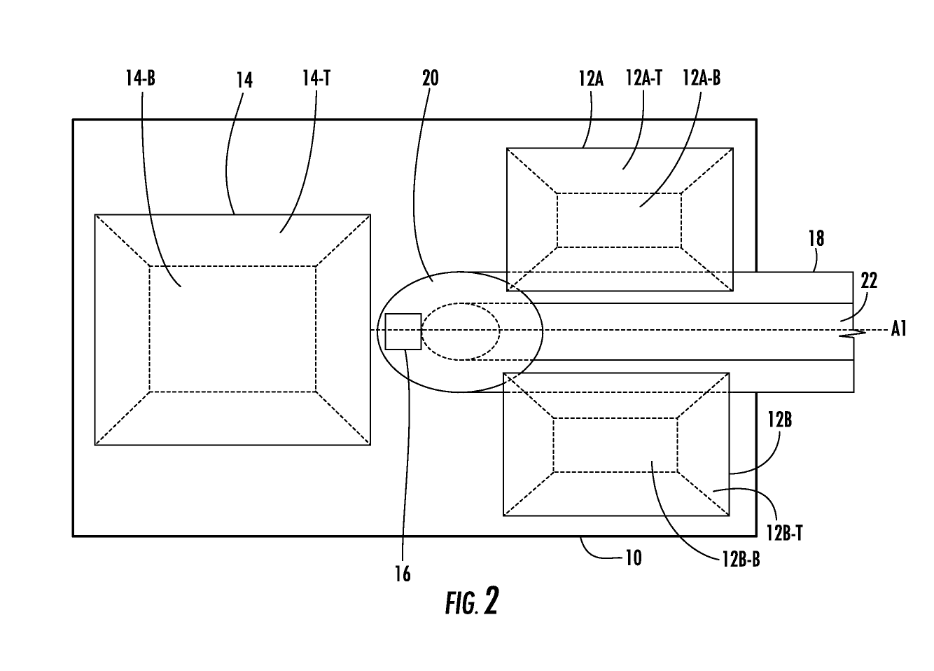

FIG. 2 is a planar view that is similar to planar view of FIG. 1 of grippers on a planar substrate arranged near an active optical element substrate, but FIG. 2 also shows an exemplary embodiment of an initial insertion of a laser angle-cleaved optical fiber 18 into the grippers 12A and 12B on the substrate 10 arranged near the optical element 16. Note that although FIG. 2 shows a laser angle-cleaved optical fiber 18 being inserted, the optical fiber 18 does not have to be laser angle-cleaved. Other optical fibers may be used in place of the laser angle-cleaved optical fiber 18. As one non-limiting example, optical fibers that provide an end, or tip, that is angled via a polishing operation, may be inserted into the grippers 12A and 12B on the substrate 10 arranged near the optical element 16. Referring once again to FIG. 2, the laser angle-cleaved optical fiber 18 has a laser angle-cleaved end facet 20 and an internal fiber core 22. In one embodiment, the laser angled end-facet 20 may comprise a single facet. In other embodiments, the laser angled end-facet 20 may comprise multiple facets, or a large number of facets that approximate a curved facet surface, where the curvature of the curved facet surface may be uniaxial or biaxial. In an example embodiment, the laser angle-cleaved optical fiber 18 is laser cleaved such that the laser angle-cleaved end facet 20 is formed at or near 45 degrees, or at other angles relative to the optical fiber axis that provide improved optical performance (e.g., reduced back reflection, increased bandwidth, etc.). The pointed shapes of the end of the laser angle-cleaved optical fiber 18 facilitate insertion of the laser angle-cleaved optical fiber 18 into channels formed by the grippers 12A and 12B on the substrate 10. When it is desired to align the laser angle-cleaved optical fiber 18 over the optical element 16, the laser angle-cleaved optical fiber 18 is inserted from the right side of FIG. 2 into the two right-side grippers 12A and 12B. The laser angle-cleaved optical fiber 18 is inserted from the right side of FIG. 2 and is moved to the left along the axis A1 by applying pressure along the axis of the laser angle-cleaved optical fiber 18. This is referred to as moving along an “axial path” of the laser angle-cleaved optical fiber 18. The grippers 12A and 12B are positioned such that they are parallel to the axial path of the laser angle-cleaved optical fiber 18 as the laser angle-cleaved optical fiber 18 is inserted. The gripper 14 is positioned such that it is in the axial path of the laser angle-cleaved optical fiber 18. Each of the grippers 12A, 12B, and 14 has a base portion attached to a surface of the substrate 10, a top surface which may be substantially parallel with the surface of the substrate 10, and side walls which provide a groove or channel between the grippers 12A and 12B. The sidewalls of each gripper 12A, 12B, and 14 may be angled somewhat, but should be sufficiently flat so that each of the grippers 12A, 12B, and 14 may contact the laser angle-cleaved optical fiber 18 in at least one point.

FIG. 3A is a side view of an exemplary embodiment of the laser angle-cleaved optical fiber 18 in FIG. 2 after insertion into the grippers 12A and 12B, showing fiber motion to the left as pressure is applied along the axis of the laser angle-cleaved optical fiber 18. While the grippers 12A and 12B (gripper 12B is not shown in the side view of FIG. 3A) hold the laser angle-cleaved optical fiber 18 in close proximity to the substrate 10, their gripping pressure on the laser angle-cleaved optical fiber 18 can be adjusted to allow the laser angle-cleaved optical fiber 18 to slide further to the left as pressure is applied along the axis of the laser angle-cleaved optical fiber 18, as shown in FIG. 3A.

As the alignment process continues, the laser angle-cleaved optical fiber 18 is continually moved to the left until contact is made between a tip of the laser angle-cleaved optical fiber 18 and the gripper 14 on the left side of FIG. 3B. The gripper 14 is positioned in the axial path of the laser angle-cleaved optical fiber 18, and is positioned such that when the tip of the laser angle-cleaved optical fiber 18 makes contact with the gripper 14, the laser angle-cleaved optical fiber 18 is positioned over the optical element 16. In one embodiment, the gripper 14 may be positioned perpendicular to the axis of the laser angle-cleaved optical fiber 18.

The laser angle-cleaved optical fiber 18 is laser angle-cleaved such that an end of the laser angle-cleaved optical fiber 18 is cleaved at an angle α relative to the axis A1. In one embodiment, the end of the laser angle-cleaved optical fiber 18 is laser-cleaved such that the angle α is formed at or near 45 degrees. The end gripper 14 is wider at the top than it is at the base. In one embodiment, the end gripper 14 has a sidewall 15 having an angle θ relative to the axis A1. It may be desirable to coordinate the sidewall angle θ of the end gripper 14 and the angle α of the end of the laser angle-cleaved optical fiber 18 in order to stop the axial movement of the laser angle-cleaved optical fiber 18 for accurate alignment of the laser angle-cleaved optical fiber 18 with the optical element 16, while at the same preventing damage to either the end gripper 14 or the end of the laser angle-cleaved optical fiber 18. The angle α of the end of the laser angle-cleaved optical fiber 18 can be any angle, although in certain embodiments the angle α will be between 30 and 45 degrees with respect to the axis A1.

The contact between a tip of the laser angle-cleaved optical fiber 18 and the gripper 14 stops the motion of the laser angle-cleaved optical fiber 18 and aligns the laser angle-cleaved end facet 20 with the optical element 16. The tapered shape of the gripper 14 also ensures that the end of the laser angle-cleaved optical fiber 18 remains in contact with the optical element 16. As seen in FIG. 3B, the laser angle-cleaved optical fiber 18 is aligned to the optical element 16 using at least one of the grippers 12A and 12B, together with the gripper 14. The gripper 14 holds the laser angle-cleaved optical fiber 18 down on the substrate 10 and limits the axial travel of the laser angle-cleaved optical fiber 18. The angled sidewalls of the gripper 14 also engage the angle-cleaved end facet 20 and force the fiber end tip down onto the optical element 16.

As shown in FIGS. 3A and 3B, the laser angle-cleaved optical fiber 18 is first coarsely aligned and mechanically restrained by grippers 12A and 12B that run parallel to the axial path of the laser angle-cleaved optical fiber 18 as the laser angle-cleaved optical fiber 18 is initially inserted into the channel between the grippers 12A and 12B. The laser angle-cleaved optical fiber 18 is then more precisely aligned to the optical element 16 by the gripper 14 that is in the axial path of the laser angle-cleaved optical fiber 18 by continually moving the laser angle-cleaved optical fiber 18 to the left until contact is made between a tip of the laser angle-cleaved optical fiber 18 and the gripper 14.

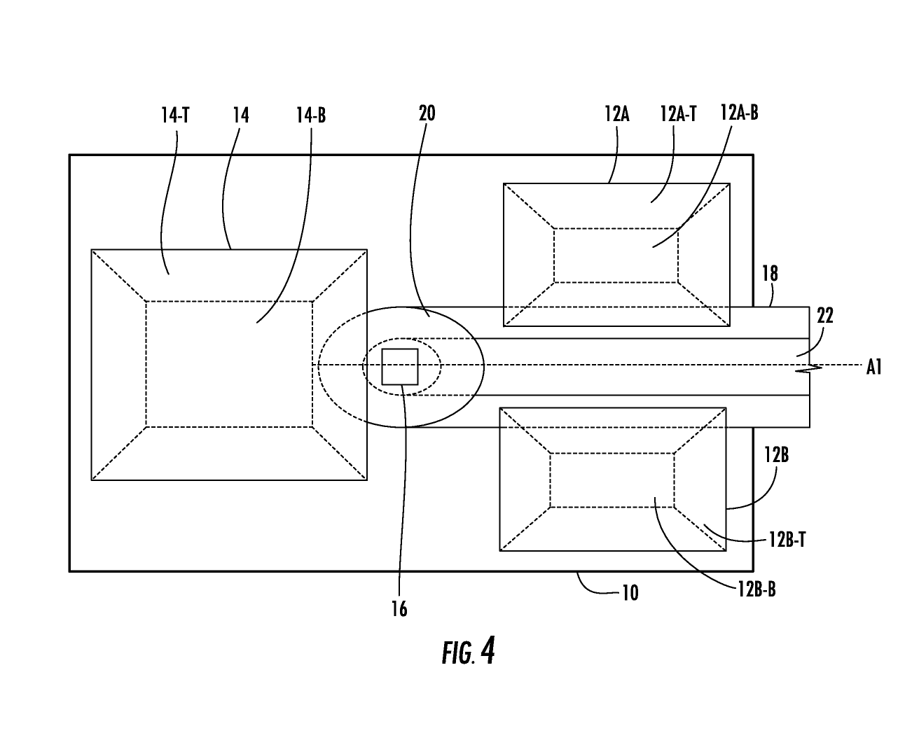

A planar view of the laser angle-cleaved optical fiber 18 held in the grippers 12A, 12B, and 14 such that the laser angle-cleaved end facet 20 of the laser angle-cleaved optical fiber 18 is positioned over the optical element 16 is shown in FIG. 4. The end gripper 14 has a base 14-B attached to a surface of the substrate 10 and a top surface 14-T in a plane parallel to the plane of the substrate 10. The end gripper 14 may have a top surface that is wider than its base, such that a footprint of the base of the end gripper 14 is smaller than the top surface of the gripper 14.

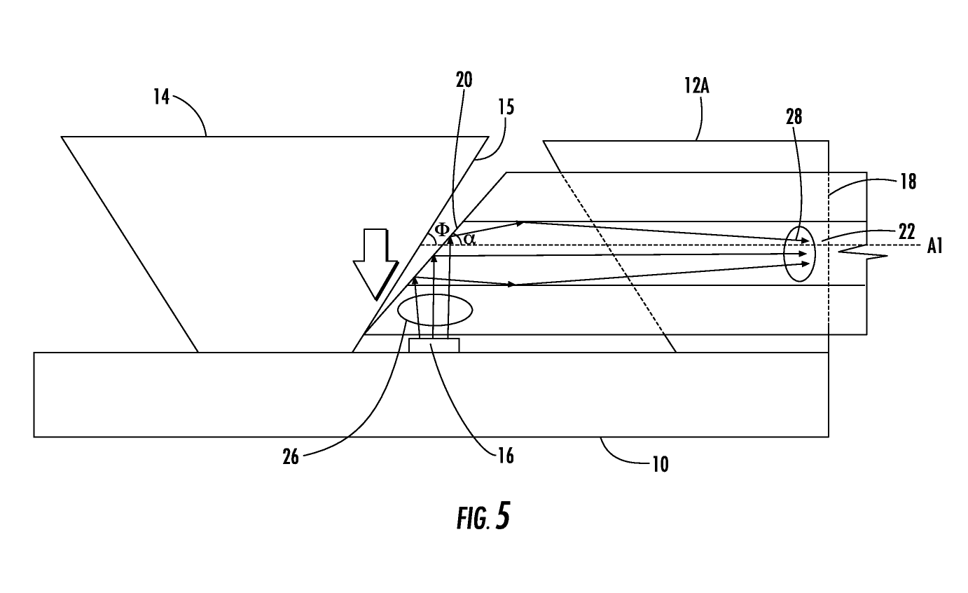

FIG. 5 is a side view of an exemplary embodiment of the laser angle-cleaved optical fiber 18 forced down into contact with the optical element 16 by a sidewall 15 of the gripper 14. As can be seen from FIGS. 4 and 5, the gripper 14 operates, either alone or in conjunction with one or more of the grippers 12A and 12B, to accurately position the laser angle-cleaved end facet 20 of the laser angle-cleaved optical fiber 18 over the optical element 16.

After the laser angle-cleaved optical fiber 18 is aligned to the optical element 16, the laser angle-cleaved end facet 20 redirects the light from the optical element 16 down the axis of the laser angle-cleaved optical fiber 18 via total internal reflection (TIR), as seen in FIG. 5. In FIG. 5, light beams 26 from the optical element 16 strike the laser angle-cleaved end facet 20 at the end of the laser angle-cleaved optical fiber 18 and are reflected as light beams 28 which are guided in the internal fiber core 22 of the laser angle-cleaved optical fiber 18.

As discussed above, it may be desirable to coordinate the sidewall angle θ of end gripper 14 and the angle α of the end of the laser angle-cleaved optical fiber 18 in order to stop the axial movement of the laser angle-cleaved optical fiber 18 for accurate alignment of the laser angle-cleaved optical fiber 18 with the optical element 16, while at the same time ensuring that there is no damage done to either the end gripper 14 or the end of the laser angle-cleaved optical fiber 18. The sidewall angle of the gripper 14 can be modified by adjusting exposure and development conditions. FIG. 5 shows a side view of the laser angle-cleaved optical fiber 18 aligned to the gripper 14 with a steeper sidewall angle Φ than the sidewall angle θ of the gripper 14 in FIGS. 3A and 3B. In the embodiment of FIG. 5, the end gripper 14 has a sidewall 15 having an angle Φ relative to the axis A1. The sidewall 15 of the gripper 14 having a steeper sidewall angle Φ in FIG. 5 may be formed by positioning a UV source above the substrate 10, but not directly overhead, and then rotating the substrate 10, as discussed in more detail below. The coordination between the sidewall angle Φ of the gripper 14 and the angle α of the end of the laser angle-cleaved optical fiber 18 also ensures that the fiber tip is forced downward into contact with the optical element 16 after assembly. The angle Φ of the sidewall 15 of the gripper 14 may be preferably chosen to be slightly larger than the angle α of the end of the laser angle-cleaved optical fiber 18. In one embodiment, the angle Φ of the sidewall 15 of the gripper 14 may be preferably chosen to be at least one to two degrees larger than the angle α of the end of the laser angle-cleaved optical fiber 18.

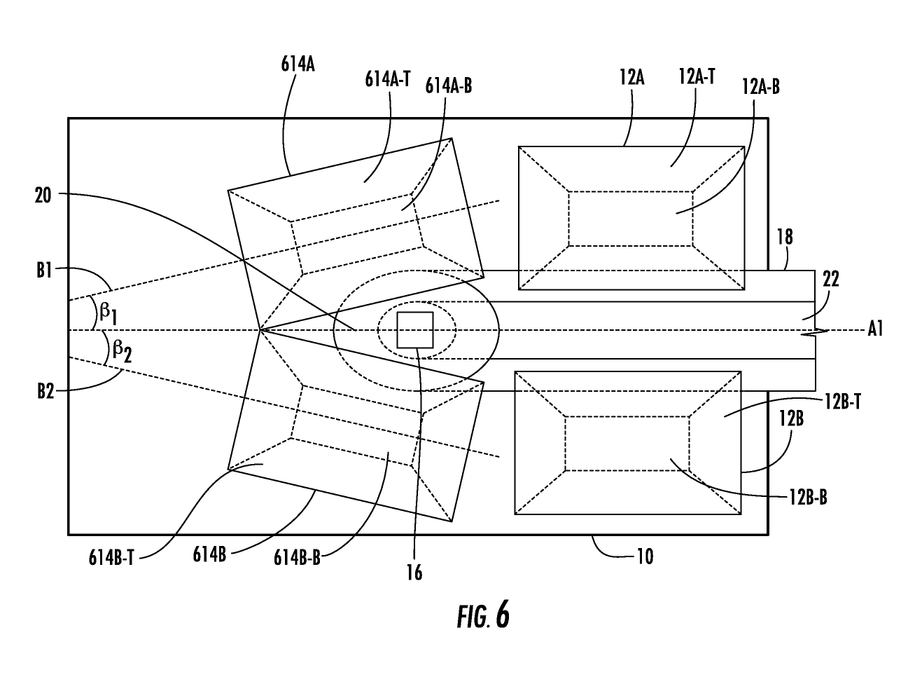

FIG. 6 is a planar view showing an exemplary embodiment of self-alignment of a laser angle-cleaved optical fiber to an active optical element using an alternative angled gripper alignment, where a pair of angled grippers is positioned in an axial path of the laser angle-cleaved optical fiber. In the exemplary embodiment of FIG. 6, the arrangement of the gripper 14 near the fiber tip may be modified to self-align the laser angle-cleaved optical fiber 18 with the optical element 16. FIG. 6 shows a gripper layout where a pair of grippers 614A and 614B are angled and positioned on each side of the tip of the laser angle-cleaved optical fiber 18.

The gripper 614A has a base 614A-B attached to a surface of the substrate 10 and a top surface 614A-T in a plane parallel to the plane of substrate 10. The gripper 614B has a base 614B-B attached to a surface of the substrate 10 and a top surface 614B-T in a plane parallel to the plane of the substrate 10. Each of the grippers 614A and 614B may have a top surface that is wider than its base, such that the footprint of the base of each of the grippers 614A and 614B is smaller than the top surface of the grippers 614A and 614B. The gripper 614A has a longitudinal axis B1 and is angled with respect to the axis A1 such that an angle exists between the axis A1 and the longitudinal axis B1 of the gripper 614A. The gripper 614B has a longitudinal axis B2 and is angled with respect to axis A1 such that the angle β₂ exists between the axis A1 and the longitudinal axis B2 of the gripper 614B. In one embodiment, the angles β₁ and β₂ may be between 30 and 45 degrees with respect to the axis A1. The longitudinal axis B1 of the gripper 614A and the longitudinal axis B2 of the gripper 614B intersect at a point along the axis A1. The grippers 614A and 614B are positioned such that the intersection point of the longitudinal axes B1 and B2 of the grippers 614A and 614B is in the axial path (i.e., along the axis A1) of the laser angle-cleaved optical fiber 18. The grippers 614A and 614B may physically touch at this intersection point, but it is not necessary that they physically touch at the intersection point. In one embodiment, the grippers 614A and 614B do not physically touch at all. The laser angle-cleaved optical fiber 18 is inserted between the grippers 12A and 12B in a manner similar to that discussed above with respect to FIGS. 2-5. As pressure is applied to the laser angle-cleaved optical fiber 18 from the right in FIG. 6, the laser angle-cleaved optical fiber 18 moves left until it comes into contact with the angled grippers 614A and 614B. The angled grippers 614A and 614B also force the fiber tip downward into contact with the optical element 16. After the laser angle-cleaved optical fiber 18 is aligned to the optical element 16 via the angled grippers 614A and 614B, the laser angle-cleaved end facet 20 redirects the light from the optical element 16 down the axis A1 of the laser angle-cleaved optical fiber 18 via total internal reflection (TIR), in a manner similar to that illustrated in FIG. 5.

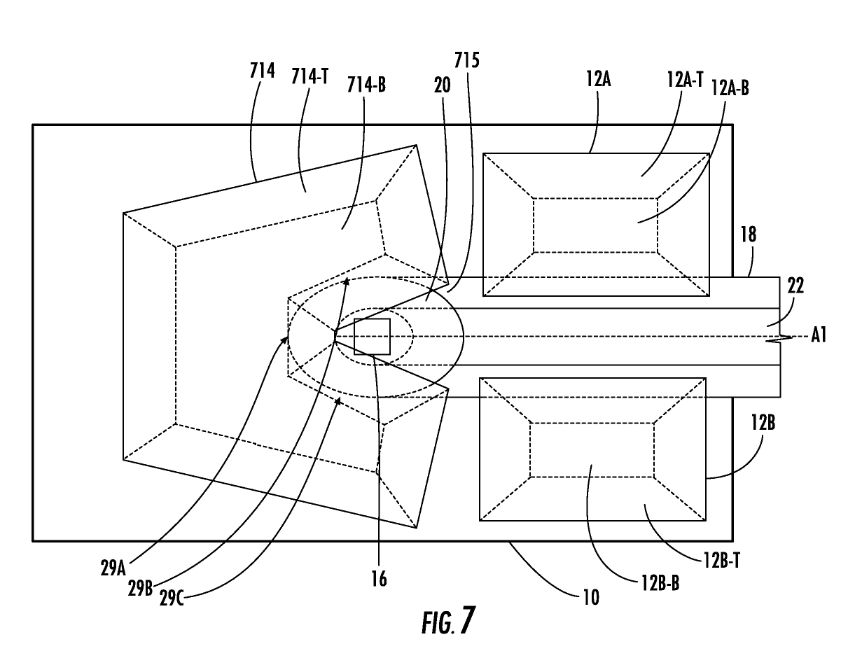

FIG. 7 is a planar view showing an exemplary embodiment of self-alignment of a laser angle-cleaved optical fiber to an active optical element using a C-shaped gripper embodiment, where a C-shaped gripper is positioned in the axial path of the laser angle-cleaved optical fiber. In FIG. 7, a single C-shaped gripper 714 has been patterned to receive the laser angle-cleaved optical fiber 18 and align it to the optical element 16 on the substrate 10. The gripper 714 has a base 714-B attached to a surface of the substrate 10 and a top surface 714-T in a plane parallel to the plane of the substrate 10. The gripper 714 may have a top surface that is wider than its base, such that the footprint of the base of the gripper 714 is smaller than the top surface of the gripper 714.

The laser angle-cleaved optical fiber 18 is inserted between the grippers 12A and 12B in a manner similar to that discussed above with respect to FIGS. 2-5. In one embodiment, the C-shaped gripper 714 has a notch 715 cut out of the gripper such that the notch is located in an axial path of the laser angle-cleaved optical fiber 18. As pressure is applied to the laser angle-cleaved optical fiber 18 from the right in FIG. 7, the laser angle-cleaved optical fiber 18 moves left until the end of the laser angle-cleaved optical fiber 18 comes into contact with the C-shaped gripper 714 at points 29A, 29B, and 29C. The C-shaped gripper 714 forces the fiber tip downward into contact with the optical element 16. After the laser angle-cleaved optical fiber 18 is aligned to the optical element 16 via the C-shaped gripper 714, the laser angle-cleaved end facet 20 redirects the light from the optical element 16 down the axis A1 of the laser angle-cleaved optical fiber 18 via total internal reflection (TIR), in a manner similar to that illustrated in FIG. 5.

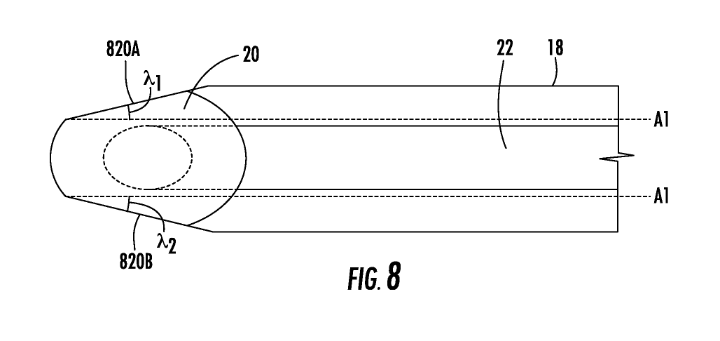

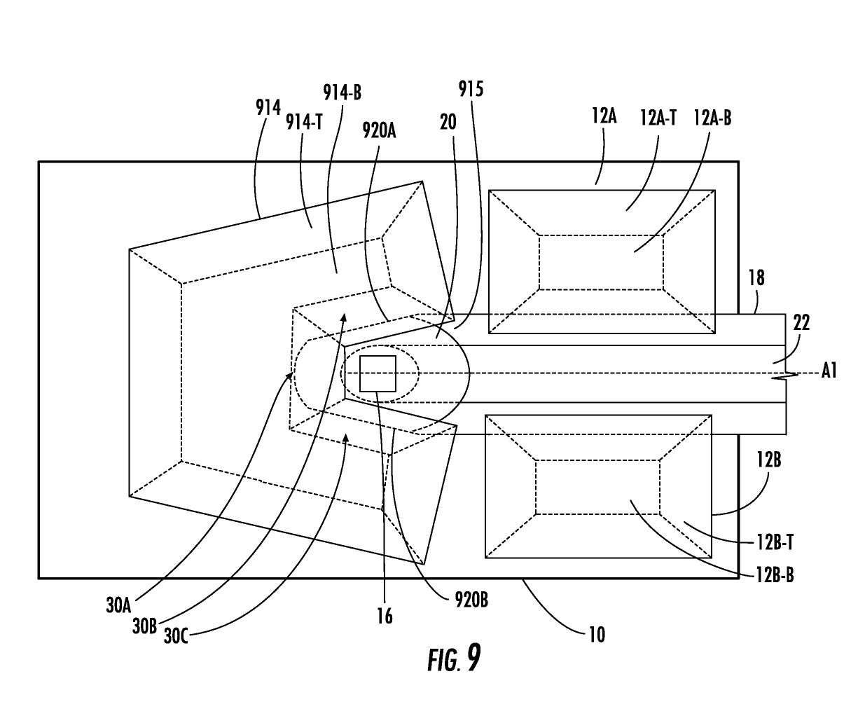

The tip of the laser angle-cleaved optical fiber 18 may also be patterned in various ways to enhance the self-alignment approach. FIG. 8 is an exemplary embodiment of side tapers on an end of the laser angle-cleaved optical fiber 18 for self-alignment to the optical element 16. FIG. 8 shows a top view of a fiber end where two additional laser-cut facets 820A and 820B are added to the original laser angle-cleaved end facet 20. The laser-cut facet 820A is laser-cleaved at an angle λ₁ with respect to the axis A1. The laser-cut facet 820B is laser-cleaved at an angle λ₂ with respect to the axis A1. A C-shaped gripper (similar to the one shown in FIG. 7) may be used to self-align the laser angle-cleaved optical fiber 18 to the optical element 16, as seen in FIG. 9.

FIG. 9 is a planar view showing an exemplary embodiment of the laser angle-cleaved optical fiber 18 with side tapers 920A and 920B being self-aligned to the optical element 16 using a C-shaped gripper 914 positioned in an axial path of the laser angle-cleaved optical fiber 18. The gripper 914 has a base 914-B attached to a surface of the substrate 10 and a top surface 914-T in a plane parallel to the plane of the substrate 10. Preferably, the C-shaped gripper 914 has a top surface 914-T that is wider than its base 914-B, such that the footprint of the base of the C-shaped gripper 914 is smaller than the top surface of the C-shaped gripper 914.

The laser angle-cleaved optical fiber 18 is inserted between the grippers 12A and 12B in a manner similar to that discussed above with respect to FIGS. 2-5. In one embodiment, the C-shaped gripper 914 has a notch 915 cut out of the gripper such that the notch is located in an axial path of the laser angle-cleaved optical fiber 18. As pressure is applied to the laser angle-cleaved optical fiber 18 from the right in FIG. 9, the laser angle-cleaved optical fiber 18 moves left until the end of the laser angle-cleaved optical fiber 18 comes into contact with the C-shaped gripper 914 at points 30A, 30B, and 30C. The C-shaped gripper 914 forces the fiber tip downward into contact with the optical element 16. After the laser angle-cleaved optical fiber 18 is aligned to the optical element 16 via the C-shaped gripper 914, the laser angle-cleaved end facet 20 redirects the light from the optical element 16 down the axis of the laser angle-cleaved optical fiber 18 via total internal reflection (TIR), in a manner similar to that illustrated in FIG. 5.

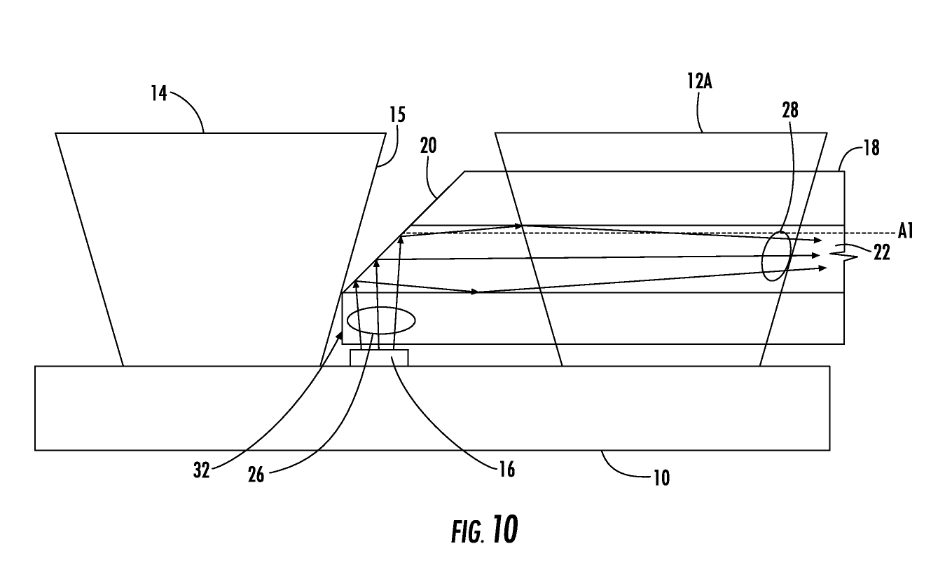

Another exemplary embodiment is shown in FIG. 10. FIG. 10 is a side view of an exemplary embodiment of the laser angle-cleaved optical fiber 18 being self-aligned via grippers 12A, 12B, and 14 over the optical element 16. In the embodiment shown in FIG. 10, the laser angle-cleaved optical fiber 18 has had a tip removed. In this manner, a flat end 32 may be formed at the end of the laser angle-cleaved optical fiber 18 to prevent the pointed fiber tip from damaging the gripper 14 during assembly. The flat end 32 comes in contact with the gripper 14 and limits the travel of the laser angle-cleaved optical fiber 18 during assembly.

It is understood that although the details of the grippers 12A, 12B, and 14 shown in FIGS. 1-7, 9, and 10 herein are particularly suitable for gripping elements adapted to secure and passively align cylindrical objects such as optical fibers, grin lenses, and the like, the grippers 12A, 12B, and 14 can be sized and configured to secure and passively align a wide variety of other types of non-cylindrical optical elements, for example, including, but not limited to, prisms, lenses, VCSELS, etc.

Gripper fabrication according to the embodiments disclosed herein may be based on well-understood photolithographic processing techniques. Moreover, gripper fabrication processes are compatible with planar active device fabrication processes.

As discussed above with respect to FIG. 5, it may be desirable for more accurate alignment of the laser angle-cleaved optical fiber 18 with the optical element 16 to try to coordinate the angle θ of the sidewall 15 of the end gripper 14 in the axial path of the laser angle-cleaved optical fiber 18 and the angle α of the end of the laser angle-cleaved optical fiber 18 to ensure that the fiber tip is forced downward into contact with the optical element 16 after assembly. The angle θ of the sidewall 15 of the gripper 14 may be chosen to be slightly larger than the angle α of the end of the laser angle-cleaved optical fiber 18. Alternatively, the angle θ of the sidewall 15 of the gripper 14 may be chosen to be slightly smaller than the angle α of the end of the laser angle-cleaved optical fiber 18. In one embodiment, the angle θ of the sidewall 15 of the end gripper 14 may be chosen to be at least one to two degrees larger than the angle α of the end of the laser angle-cleaved optical fiber 18.

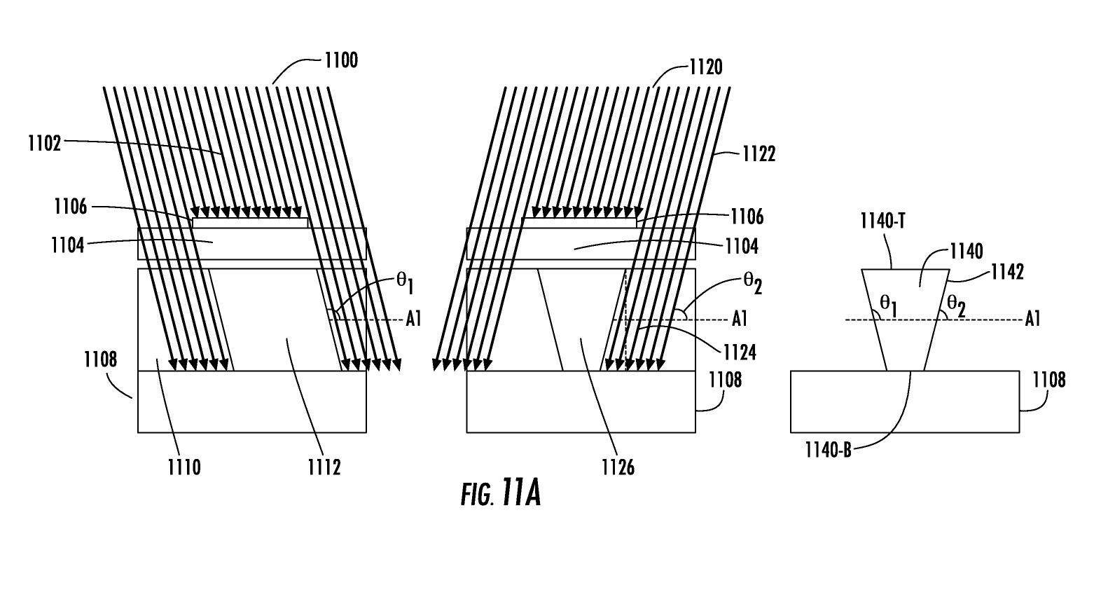

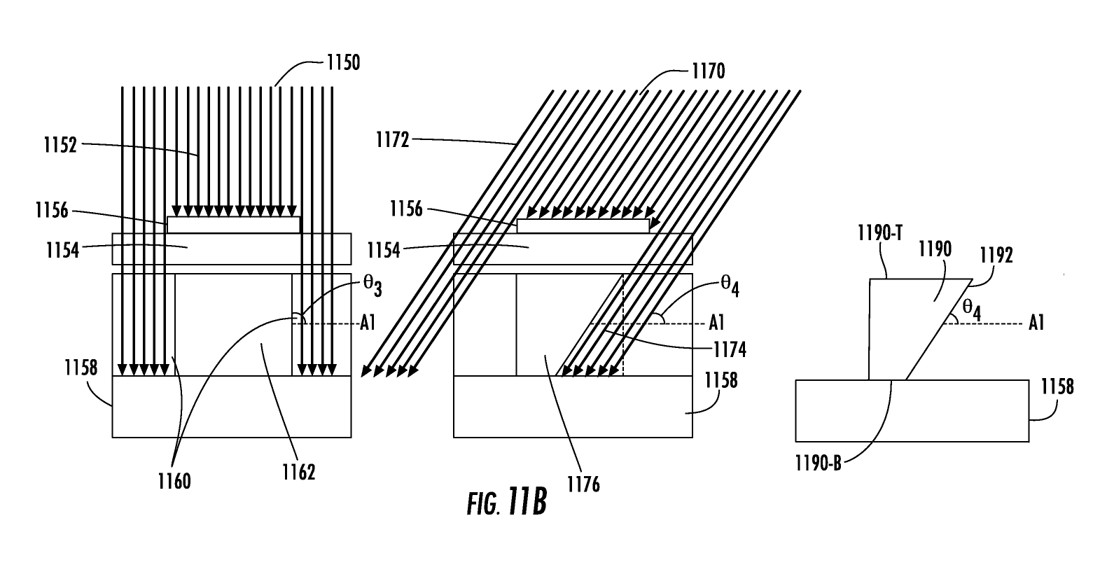

The gripper sidewall angle is easily modified by adjusting UV exposure and development conditions. For example, steeper sidewall angles may be obtained by exposing the polymer grippers through a mask at an angle, as shown in FIGS. 11A and 11B. The UV source may also be rotated relative to the device substrate during exposure to increase the sidewall angle further.

FIG. 11A shows the standard gripper exposure process, where the direction of the UV exposure is close to the substrate normal direction. In part 1100 of the process, UV light 1102 is applied to a mask substrate 1104 having a mask pattern 1106 for the desired polymer gripper such that the portions of a polymer gripper substrate 1108 is exposed to the UV light 1102. The UV light 1102 is applied at an angle θ₁ with respect to the axis A1, which is parallel to the polymer gripper substrate 1108. The portion of the polymer gripper substrate 1108 that is exposed to the UV light 1102 is exposed polymer gripper material 1110 and the portion of the polymer gripper substrate 1108 that is not exposed to the UV light 1102 due to the mask pattern 1106 is unexposed polymer gripper material 1112. At part 1120 of the process, there is a second UV exposure from a second direction at a second angle, θ₂, with respect to the axis A1. UV light 1122 is applied to the mask substrate 1104 having a mask pattern 1106 such that another portion (labeled 1124) of the previously unexposed polymer gripper material 1112 is now exposed to UV light 1122, leaving only portion 1126 as unexposed polymer gripper material. Then, the removal of all exposed polymer gripper material is performed so that only a polymer gripper 1140 remains. The polymer gripper 1140 has a top surface 1140-T and a base 1140-B, where the top surface 1140-T is preferably wider than the base 1140-B. The polymer gripper 1140 has a sidewall 1142 having an angle θ₂, with respect to the axis A1. The angular variation in exposure can be provided by positioning the polymer gripper substrate 1108 on a rotating plate, with the source of the UV light positioned above the plate so that the UV light is directed down on the polymer gripper substrate 1108 at a slight angle relative to the substrate normal angle.

FIG. 11B shows a modified gripper exposure process, wherein at least one direction of the UV exposure is at a sharper (i.e. larger) angle with respect to the substrate normal direction in order to obtain a steeper (i.e., more acute, relative to the plane of the substrate) sidewall angle on the formed polymer gripper. In part 1150 of the process, UV light 1152 is applied to a mask substrate 1154 having a mask pattern 1156 for the desired polymer gripper such that the portions of a polymer gripper substrate 1158 is exposed to the UV light 1152. The UV light 1152 is applied in a direction that is normal to the polymer gripper substrate 1158. That is, the UV light 1152 is applied at an angle θ₃, where θ₃ is 90 degrees with respect to the axis A1, which is parallel to the polymer gripper substrate 1158. The portion of the polymer gripper substrate 1158 that is exposed to the UV light 1152 is exposed polymer gripper material 1160 and the portion of the polymer gripper substrate 1158 that is not exposed to the UV light 1152 due to the mask pattern 1156 is unexposed polymer gripper material 1162. At part 1170 of the process, there is a second UV exposure from a second direction and at a second angle, θ₄, with respect to the axis A1, which is at an angle that is sharper (i.e., larger) with respect to the substrate normal direction as compared to the angle θ₂ of the UV exposures in the normal process of FIG. 11A. UV light 1172 is applied to the mask substrate 1154 having a mask pattern 1156 such that another portion (labeled 1174) of the previously unexposed polymer gripper material 1162 is now exposed to UV light 1172, leaving only a portion 1176 as unexposed polymer gripper material. Then, the removal of all exposed polymer gripper material is performed so that only polymer gripper 1190 remains. The polymer gripper 1190 has a top surface 1190-T and a base 1190-B, where the top surface 1190-T is preferably wider than the base 1190-B. The polymer gripper 1190 has a sidewall 1192 having an angle θ₄, with respect to axis A1. Polymer gripper 1190 has a steeper sidewall angle, θ₄, than the polymer gripper 1140 formed by the normal UV exposure process of FIG. 11A. The angular variation in exposure can be provided by positioning the polymer gripper substrate 1158 on a rotating plate, with the source of the UV light positioned above the plate so that the UV light is directed down on the polymer gripper substrate 1158 at an angle relative to the substrate normal, or it may be provided via UV illumination of a fixed polymer gripper substrate 1158 from several different angles.

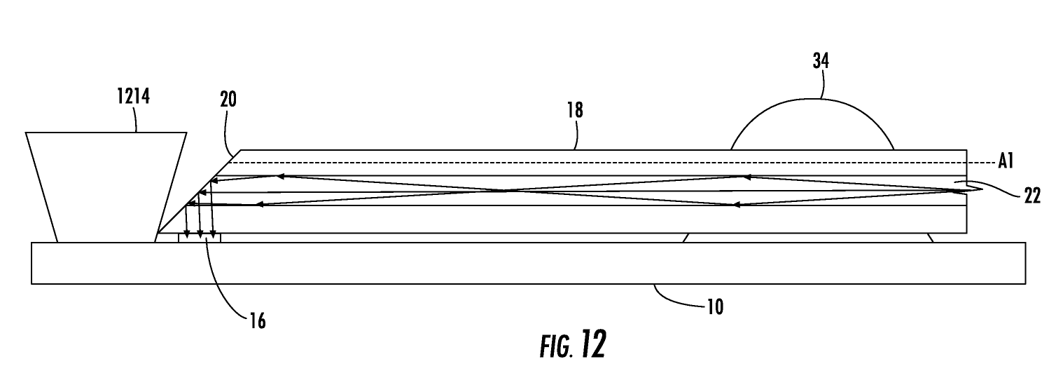

According to some embodiments, cement or adhesive may be used to coarsely align and mechanically restrain the optical fibers, in place of the grippers that run parallel to the optical fiber, such as grippers 12A and 12B. FIG. 12 shows such an embodiment. In FIG. 12, the laser angle-cleaved optical fiber 18 is coarsely aligned and mechanically restrained by adhesive 34, which is deposited over the laser angle-cleaved optical fiber 18. The adhesive 34 thus acts as a restraining member for the laser angle-cleaved optical fiber 18. The laser angle-cleaved optical fiber 18 is then precisely aligned to the optical element 16 by the gripper 1214, which is located in the axial path of the laser angle-cleaved optical fiber 18. The gripper 1214 can be a single gripper like the gripper 14 in FIGS. 1-6 and 10, a pair of angled grippers like the grippers 614A and 614B in FIG. 6, or a C-shaped gripper like the gripper 714 in FIG. 7, or the gripper 914 in FIG. 9, or a similar gripper structure. The gripper 1214 forces the tip of laser angle-cleaved optical fiber 18 downward into contact with the optical element 16. After the laser angle-cleaved optical fiber 18 is aligned to the optical element 16 via the gripper 1214, the laser angle-cleaved end facet 20 redirects the light from the optical element 16 down the axis of the laser angle-cleaved optical fiber 18 via total internal reflection (TIR), in a manner similar to that illustrated in FIG. 5.

Certain embodiments disclosed herein relate to apparatuses and methods for alignment of various optical elements to substrates. These optical elements may include for example, but are not limited to, optical fibers, lenses, filters, lensed fibers, vertical cavity surface emitting lasers (VCSELs), optical isolators, photonic detectors, and the like. In certain embodiments, an end of an optical fiber, such as a laser angle-cleaved optical fiber, is aligned over an active optical element, such as a VCSEL, on a substrate. The apparatuses and methods may include a substrate that includes alignment features or receiving structures, for example, gripping elements, v-grooves, depressions, recessed regions, keys, trenches, adhesives, or cement, for securing and passively aligning optical modules or modular optical elements. Fiber alignment structures such as grippers may also be used to position fibers normal to the substrate surface, so that fibers pass through a 1-D or 2-D array of apertures in an alignment plate. The grippers may be fowled using deformable mechanical members or by filling a portion of the plate aperture with a polymer gripper material. Fibers in this configuration may be fixed in place using various forms of polymer encapsulation.

Fiber gripping structures have also been employed in mechanical splices, where plastic deformable V-grooves may be used to align and restrain one or more mated optical fiber pairs. Fibers can also be held in position using deformable plastic grooves with sidewall barbs that grip the fiber.

Certain embodiments disclosed herein include grippers, such as polymer grippers, for passive alignment of components on planar substrates. Although polymer grippers are disclosed herein for passive alignment, other structures, such as restraining members, may also be used to provide alignment and/or mechanical restraint of optical fibers or other optical elements.

Grippers can be used to hold optical fibers in place on flat substrates or in V-groove structures formed on silicon substrates. In addition to gripping individual fibers, grippers can be used for positioning arrays of optical fibers, optical components mounted on smaller carrier substrates, fiber lenses, cylindrical lenses and resonator structures, and optical filters.

Embodiments described herein include techniques for aligning laser angle-cleaved optical fibers to active devices on a planar substrate (e.g., VCSEL sources and photodetectors) using grippers, such as polymer grippers. Grippers ensure that the tapered or laser angle-cleaved fiber ends are precisely aligned to active components (laser sources or detectors). Grippers can also ensure that the fiber end is held in close proximity to the active device. By positioning the one or more grippers in the axial path of the optical fiber such that an optical fiber may be moved along the axial path until the end of the optical fiber comes in contact with the one or more grippers, the optical fiber may be easily and accurately aligned over an active optical element on a substrate.

An advantage of using grippers, such as polymer grippers, is that it enables low-cost passive alignment of tapered fibers or fiber arrays to active optical devices. In addition, the polymer gripper layout can be easily modified via photolithographic mask modification to accommodate any type of fiber end treatment (e.g., wedges or tapers).

Certain embodiments disclosed herein provide passive alignment apparatus and methods that are inexpensive and require very few steps to achieve passive alignment of various optical elements. After the elements have been passively aligned, it may be desirable to use cement or adhesive to aid in securing the optical element in place. Alternatively, in other embodiments, no adhesive needs to be used. In the design of optical devices, if the proper positional and angular alignment of the individual optical elements is known, the alignment features on the bases and on the substrate can be designed and properly positioned to achieve passive alignment.

According to certain embodiments, a variety of materials and geometric shapes can be used for the gripping elements and the substrate, and a variety of manufacturing procedures may be used to fabricate them. The embodiments disclosed herein allow for low cost passive alignment of optical elements.

Further, as used herein, it is intended that terms “fiber optic cables” and/or “optical fibers” include all types of single mode and multi-mode light waveguides, including one or more bare optical fibers, loose-tube optical fibers, tight-buffered optical fibers, ribbonized optical fibers, bend-insensitive optical fibers, or any other expedient of a medium for transmitting light signals. An example of a bend-insensitive optical fiber is ClearCurve® optical fiber, manufactured by Corning Incorporated.

Many modifications and other embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

1. An apparatus for optical fiber alignment, comprising:
a substrate;
an optical element disposed on the substrate and defining an axial path; and
at least one gripper element disposed on the substrate and positioned in the axial path, such that when an optical fiber is moved along the axial path until an end of the optical fiber makes contact with the at least one gripper element, the optical fiber is aligned with the optical element.

2. The apparatus of claim 1, wherein the optical fiber comprises an angled end.

3. The apparatus of claim 2, wherein the angled end is a polished angled end.

4. The apparatus of claim 1, wherein the optical fiber is a laser angle-cleaved optical fiber comprising at least one laser angle-cleaved end facet.

5. The apparatus of claim 1, wherein the at least one gripper element is positioned perpendicular to the axial path of the optical fiber.

6. The apparatus of claim 1, wherein the at least one gripper element comprises a polymer gripper.

7. The apparatus of claim 1, wherein the substrate further comprises at least one restraining member positioned parallel to the axial path.

8. The apparatus of claim 7, wherein the at least one restraining member comprises at least one polymer gripper.

9. The apparatus of claim 7, wherein the at least one restraining member comprises an adhesive.

10. The apparatus of claim 1, wherein the substrate further comprises at least one pair of spaced restraining members positioned parallel to the axial path and configured to partially restrain the optical fiber.

11. The apparatus of claim 10, wherein the at least one pair of spaced restraining members is configured to coarsely align the optical fiber, and the at least one gripper element further aligns the optical fiber with the optical element.

12. The apparatus of claim 1, wherein the at least one gripper element comprises a pair of angled polymer grippers.

13. The apparatus of claim 1, wherein the at least one gripper element comprises at least one C-shaped polymer gripper.

14. The apparatus of claim 1, wherein the optical fiber is a laser angle-cleaved optical fiber comprising a plurality of laser angle-cleaved end facets.

15. The apparatus of claim 4, wherein an angle of a sidewall of the at least one gripper element is adapted to correspond to an angle of the at least one laser angle-cleaved end facet of the laser angle-cleaved optical fiber.

16. The apparatus of claim 1, wherein the at least one gripper element is formed via an ultraviolet (UV) exposure process.

17. The apparatus of claim 15, wherein the angle of the sidewall of the gripper element is modified by changing an angle of UV light in a UV exposure process used to form the at least one gripper element.

18. The apparatus of claim 4, wherein a tip of the laser angle-cleaved optical fiber is removed to form a flat end of the laser angle-cleaved optical fiber, wherein when the flat end comes into contact with the at least one gripper element, the flat end limits travel of the laser angle-cleaved optical fiber.

19. The apparatus of claim 1, wherein the optical element is an optical component selected from a group comprising a vertical cavity surface emitting laser (VCSEL), a photodetector, a laser, an optical fiber, a lens, a filter, a lensed fiber, and an optical isolator.

20. A method of aligning an optical fiber over an optical element on a substrate comprising:
providing at least one gripper element disposed on the substrate and positioned in an axial path defined by the optical element; and
moving the optical fiber along the axial path until the optical fiber is in contact with the at least one gripper element.

21. The method of claim 20, wherein the optical fiber is a laser angle-cleaved optical fiber having at least one laser angle-cleaved end facet.

22. The method of claim 20, wherein at least one end of the optical fiber is angled via a polishing operation.

23. The method of claim 20 further comprising providing at least one restraining member positioned parallel to the axial path of the optical fiber.

24. The method of claim 20 further comprising providing at least one pair of spaced restraining members positioned parallel to the axial path to restrain the optical fiber in position.

25. The method of claim 23, wherein providing the at least one restraining member comprises depositing an adhesive over the optical fiber.

26. The method of claim 20 wherein providing the at least one gripper element further comprises providing a pair of angled polymer grippers.

27. The method of claim 20, wherein providing the at least one gripper element further comprises providing at least one C-shaped polymer gripper.

28. The method of claim 21, wherein providing the at least one gripper element further comprises providing at least one gripper element having a sidewall with an angle that corresponds to an angle of the at least one laser angle-cleaved end facet of the laser angle-cleaved optical fiber.

29. The method of claim 24, further comprising:
coarsely aligning the optical fiber using the pair of spaced restraining members positioned parallel to the axial path of the optical fiber; and
performing a further alignment of the optical fiber with the optical element using the at least one gripper element.

30. An apparatus for optical fiber alignment, comprising:
a substrate;
an optical element disposed on the substrate and defining an axial path;
at least one pair of side polymer gripper elements disposed on the substrate and positioned parallel to the axial path; and
at least one end polymer gripper element comprising a sidewall having an angle with respect to the axial path, the at least one end polymer gripper element disposed on the substrate and positioned in the axial path, such that when a laser angle-cleaved optical fiber comprising at least one laser angle-cleaved end facet is moved along the axial path until a tip of the laser angle-cleaved optical fiber makes contact with the at least one end polymer gripper element,
the laser angle-cleaved optical fiber is aligned with the optical element,
wherein the at least one pair of side polymer gripper elements is configured to partially restrain the optical fiber, the at least one end polymer gripper element is configured to align the laser angle-cleaved optical fiber with the optical element, and the angle of the sidewall of the at least one end polymer gripper element is configured to correspond to an angle of the at least one laser angle-cleaved end facet.

31. The apparatus of claim 1, wherein the gripper element is a deformable member that applies downward pressure on the optical fiber to hold the optical fiber in place.

32. The apparatus of claim 1, wherein a sidewall of the gripper element engages the end of the optical fiber and forces the end of the optical fiber down toward the optical element.
